(19) United States
(12) Patent Application Publication
(10) Pub. No.: US 2003/0061139 A1
(43) Pub. Date: Mar. 27, 2003

(54) Method and system for diversifying risk in privately-held stock

(76) Inventor: John Roberts, Kanata (CA)

Correspondence Address: DUANE MORRIS LLP, 100 COLLEGE ROAD WEST, SUITE 100, PRINCETON, NJ, 08540-6604, US

(21) Appl. No.: 09/965,443

(22) Filed: Sep. 27, 2001

(51) Int. Cl. G06F 17/60

(52) U.S. Cl. 705/36

(57) ABSTRACT

A private trust used to diversify risk for holders of stock in private companies that have received venture capital funding. The private trust accepts donations of the stock in exchange for trust units. The private trust pools the stock and manages the stock to yield income for trust unit holders. The private trust holds the stock until after initial public offering and escrow restrictions have expired. The public shares are then sold at the discretion of trust managers to earn the income for the private trust. Shares of pre-approved companies may be donated to the private trust using worldwide web enabled forms. The private trust diversifies risk because income/losses from trust units flow collectively from all privately-held shares managed by the private trust.

### CROSS-REFERENCE TO RELATED APPLICATIONS

This is the first application filed for the present invention.

### MICROFICHE APPENDIX

Not applicable.

### TECHNICAL FIELD

This invention relates in general to automated systems for managing financial instruments and, in particular, to a method and system for diversifying risk in privately-held stock by pooling stock in a managed private trust fund.

### BACKGROUND OF THE INVENTION

At the turn of the century the valuations of new companies with unproven technology and business models reached extraordinary heights. Many companies gained remarkable valuations and substantial angel and investor capital investment. These valuations have since declined dramatically, and the usual exit opportunities such as initial public offerings (IPOs) and acquisitions have all but disappeared in the current downturn. Companies which have survived and gained new private investment are those with a clear path to profits and sound management teams. Even for these more successful entities, the exit opportunities are limited and more distant. Angel investors and founder management personnel have been shocked by these changes. Uncertain even of the timeframe and most certainly the valuation of an exit event, they are seeking a way to diversify their holdings in order to reduce their risk.

It is well known that diversifying holdings is one way of reducing risk. While gains of successful mezzanine venture capital funds range from 28% to 48% annually averaged over five years, these gains are not obtained consistently. In fact, only about two out of ten of the investments yield up to 80% of the total return. In the current economy, investment turnover rates have slowed dramatically, liquidity events are delayed and uncertainty is predominant. However, when investments by venture capital investors are made, they invest substantial amounts. The venture capital deals place those companies under pressure, because a common tactic of venture capitalist is to impose “ratchet clauses” (performance requirements) and to insist upon special preferred shares that have superior rates to the shares owned by entrepreneurs and the early-stage angel investors. The founders and angel investors are therefore under threat. They are very vulnerable and while the tactics of the venture capitalist will possibly gain extra performance from the companies, the effect is to open the possibility of third-party acquisition of some of the founder stock.

There therefore exists a need for a financial instrument which permits holders of stock in private companies to diversify their risk and, if required, gain liquidity prior to a liquidity event in the private company.

### SUMMARY OF THE INVENTION

It is therefore an object of the invention to provide a method and system for diversifying risk in privately-held stock.

It is a further object of the invention to provide a method for diversifying risk in privately-held stock by providing a private trust in which stock is pooled by a plurality of donors.

In accordance with the method, privately-held stock donations are accepted into a trust in exchange for trust units. The trust may be a private trust, at least in startup phases. The privately-held stock is held by the trust until the private company is sold, or performs an initial public offering to convert the privately-held stock to public stock. Trust managers determine when the public stock is to be sold. Income realized from the sale of public stock, and other income generated by the trust under direction of the trust managers, is distributed to the trust unit holders. The private trust may be converted to a closed-end mutual fund after the private trust has attained sufficient worth.

The system facilitates management of the trust by the trust managers, as well as enabling potential donors to learn about the trust and to donate their privately-held stock to the trust. The system comprises a trust management server and a trust web server. The trust management server facilitates management of the trust by providing the trust managers with access to trust information and computing income distributions. The trust web server permits potential donors to search for and/or submit public information respecting the private company in which they hold stock. A potential donor may also use the trust web server to submit private information respecting a company in which they hold stock. The public information is posted on the trust web server, but the private information is protected with embedded security codes so that only a trust manager can view it.

A secure web form permits the potential donor to provisionally donate privately-held stock to the trust. The donation is subject to approval by a trust manager, and receipt of the private trust certificates and required permission letter(s). After a donation is approved and accepted, trust units are held in perpetuity, but may be sold with permission of trust trustees.

The invention therefore provides a method and system for diversifying risk and providing improved liquidity for investors in private companies that have achieved enough success to have obtained a significant venture capital investment.

### BRIEF DESCRIPTION OF THE DRAWINGS

Further features and advantages of the present invention will become apparent from the following detailed description, taken in combination with the appended drawings, in which:

FIG. 1 is a schematic diagram of a private trust in accordance with the invention illustrating exemplary transactions conducted between the trust and various parties that conduct transactions with the trust;

FIG. 2 is a schematic diagram of an overview of components of the system in accordance with the invention shown in an environment in which the system is used;

FIG. 3 is a schematic message flow diagram showing principal messages exchanged between a donor and components of the system when privately-held stock is donated to the trust using forms available on the public trust web server;

FIG. 4 is a schematic diagram of a donor workstation running a web browser which is used to access web forms for donating private stock to the trust, as well as web forms used for submitting information related to a particular private company;

FIG. 5 is a message flow diagram showing an exemplary message exchanged between a potential donor to the trust and the trust web server, the donor supplying publicly-available information related to a private company;

FIG. 6 is a message flow diagram showing principal messages exchanged between a potential donor and the trust web server to provide confidential information related to the private company to managers of the trust; and

FIG. 7 is a schematic diagram illustrating one embodiment of the invention in which the trust is converted to a closed-end mutual fund after the private trust has achieved a certain size.

It will be noted that throughout the appended drawings, like features are identified by like reference numerals.

### DETAILED DESCRIPTION OF THE PREFERRED EMBODIMENT

The present invention provides a system and method for diversifying risk in privately-held stock by permitting a holder of the private stock to donate the stock to a private trust. The private trust is managed to earn revenue. The earned revenue is distributed to owners of private trust units. The private trust units are held in perpetuity, but may be traded or sold within limits imposed by trustees of the private trust. Once the trust has achieved a certain size, it may converted to a closed-end mutual fund.

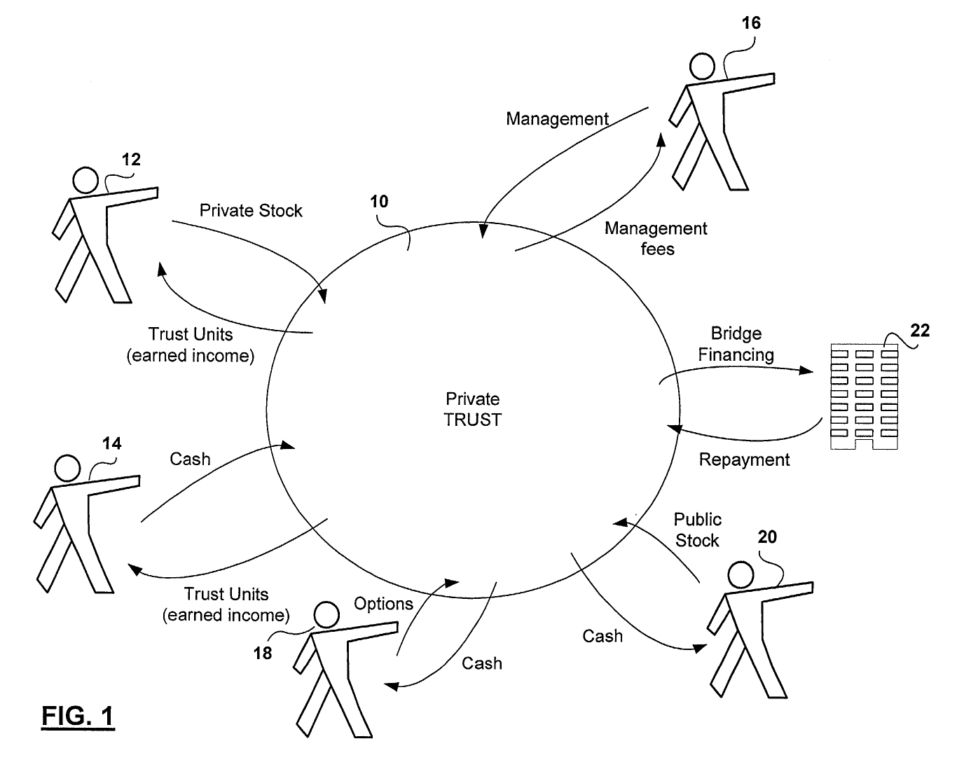

FIG. 1 is a schematic diagram illustrating exemplary transactions between a private trust 10 and entities that transact with the private trust. Those entities include, for example, holders 12 of private stock who donate the private stock to the private trust 10. The private trust 10 therefore acquires private stock without cost. In return for the donation, the holder 12 of private stock receives trust units. The trust units entitle the trust unit owner to earn income which is distributed from the trust, as will be explained below in more detail. Once a holder 12 of private stock has donated his stock to the trust and become a trust unit owner, the owner owns the trust units in perpetuity. Since the trust is a private trust, the owner of trust units may only sell the trust units with the permission of trustees of the private trust 10, who may be required to approve the sale, as well as approve the purchaser of the trust units.

In addition to private stock, contributions to the private trust 10 may be made in the form of cash by a cash donor 14. The cash donor 14 receives trust units in return for cash donations to the private trust 10. Each trust unit has a pre-assigned value that determines the number of trust units issued to the cash donor 14, based on the amount of cash donated to the private trust.

The private trust 10 is managed by professional managers 16. In return for management services, the private trust pays management fees in accordance with contractual agreements between the private trust 10 and the trust managers 16. In addition to determining which private companies the private trust 10 will accept stock donations from, the managers 16 are responsible for determining if and when the private trust 10 will conduct other transactions. For example, a private trust 10 may buy stock options from a stock option holder 18 who is unable to exercise the options for any one of a number of reasons. Stock options are acquired in exchange for cash paid from the private trust 10. Once the stock options are acquired, the managers 16 manage the options to earn income for the private trust 10 by exercising the options at a time that the managers 16 deem appropriate, and selling stocks realized from exercising the options. Manager 16 may also acquire public stock from a stock holder 20 in exchange for cash. For example, a stock holder may be precluded by an escrow agreement from selling stock on the public market. In order to realize liquidity, the public stock may be sold by the stock holder 20 to the private trust at a discount, with the provision that the escrow agreement be respected. The private trust 10 may also provide bridge financing to companies preparing for an initial public offering (pre-IPO) in order to earn income for the private trust 10. The pre-IPO company 22 is loaned cash reserves from the private trust 10, which are repaid in accordance with a repayment schedule negotiated by the managers 16. The companies may be, for example, companies in which the private trust 10 holds stock.

It should be noted that the transactions shown in FIG. 1 are exemplary only, and do not constitute an exhaustive list of transactions that may be conducted by managers 16 of the private trust 10.

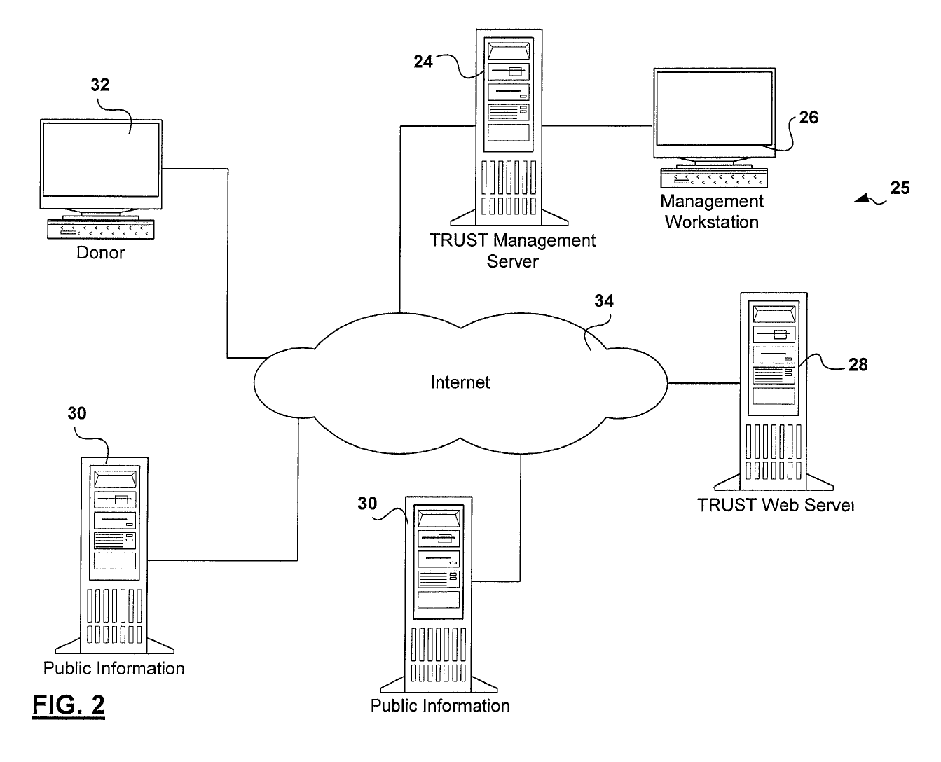

In order to manage and promote the private trust 10, the private trust 10 owns and operates a trust management system 25 shown in FIG. 2. The trust management system 25 includes a trust management server 24 that directly or indirectly supports one or more management workstations 26, which are used by the private trust managers 16 to manage the private trust 10. The trust management server 24 is preferably connected to the Internet 34 in a manner well known in the art. The trust management server 24 facilitates management of the private trust 10 by providing management tools, such as memories such as disk drives for storing contact information related to holders of units of the private trust 10; information related to each private company in which the private trust 10 holds an ownership interest, including information defining the privately-held stock; and, information related to cash and other assets owned by the trust. The trust management server also has a processor for executing program instructions that permit all of the above information to be written, read and rewritten, as required. Programs are also provided to permit trust managers 16 to input information related to a donation of private shares in a private company to the private trust 10, the information identifying the company, the owner of the private shares and a value of each share. The trust management server 24 also has programs for computing a number of units to be issued to the donor of the private shares, and for computing a share of income from the private trust to be distributed to each holder of the units in the private trust 10. The share of income is preferably computed in direct relationship to the number of units held.

The trust management system 25 further includes a trust web server 38 which may be implemented on the trust management server 24, or implemented as a stand-alone public server, also in a manner well known in the art.

The trust managers 16 use public information sources 30, such as news servers, and the like, to gather information about private companies in order to determine from which private companies private stock will be accepted as donations to the private trust 10. In general, the private trust 10 preferably only accepts donations of private stock in companies that have recently acquired significant venture capital funding. This has several distinct advantages. First, it is normal procedure for venture capital investors to perform extensive due diligence to determine whether the company's objectives and management structure warrant venture capital investment. The due diligence generally results in the assignment of a value to privately-held stock in the company. Assuming that venture capital was recently acquired by the privately-held company, managers 16 of the private trust 10 can accept the evaluation of the privately-held shares assigned when the venture capital was acquired. Thus management effort is reduced. Second, since the venture capital funding was recently acquired, the company is an above-average risk in terms of an investment opportunity. Third, when venture capital funding is acquired, the transaction normally becomes public knowledge and most of the particulars of the transaction are publicly available from public information sources 30, such as, for example, business newspapers, magazines and other publications which provide extensive information about the company, its structure, its products and, quite often, also provide the evaluation assigned to the privately-held stock in the company.

Consequently, the private trust managers 16 search public information servers 30 to acquire information about companies in which private stock will be accepted as donations to the private trust 10. Lists of eligible companies may be compiled by the private trust managers 16. However, those lists are preferably not made public. As will be explained below in some detail, however, a donor using workstation 32 connected to the Internet 34 may complete a form requesting that the managers 16 of the private trust 10 accept a donation of his privately-held stock. The form is accessed by accessing the trust web server 28 in a manner well known in the art.

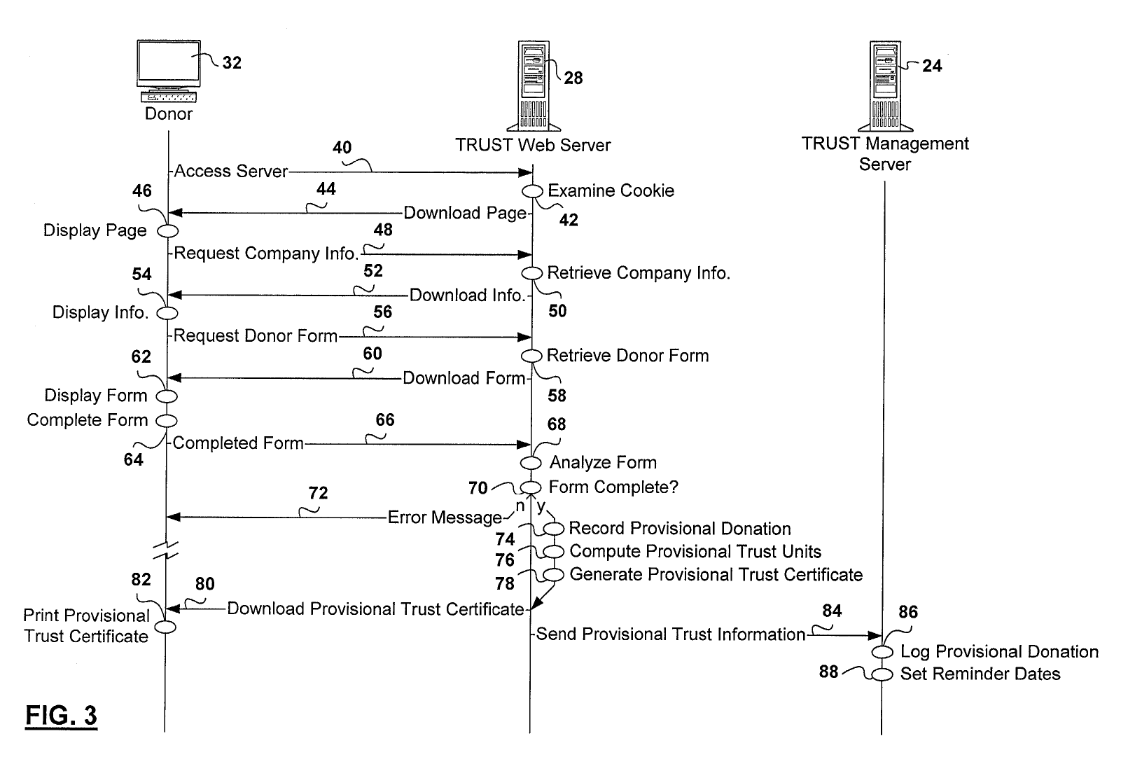

FIG. 3 is a schematic diagram of information exchanged between a potential donor and the trust management system 25 when the potential donor submits a request that the private trust 10 accept a donation of private shares. The process begins when a potential donor using the donor workstation 32 accesses the trust web server 28 by entering an appropriate universal resource locator (URL), in a manner well known in the art. The trust web server 28 may respond to the request for access by examining a cookie previously stored in the donor workstation 32, also in a manner well known in the art, in order to determine whether the donor is a repeat visitor and requires specialized or personalized web pages (step 42). The trust web server 28 selects an appropriate page and downloads that page in step 44. The donor workstation 32 displays the downloaded page in step 46. Assuming that the potential donor is a first-time visitor to the trust web server 28, the donor may begin by requesting information stored on the web server about the potential donor's company (step 48). The trust web server 28 responds by retrieving stored information accumulated by the trust manager 16 (step 50) and downloads the information (step 52). The information is displayed by the potential donor's workstation 32 (step 54). After reviewing the information, the potential donor requests (step 56) a donor form by selecting an appropriate button from the page downloaded by the trust web server. The button (not shown) may be selectively displayed with information about companies from which the trust managers 16 are willing to accept donations of private stock. In step 58, the donor form is retrieved by the trust web server 28 and downloaded (step 60). The donor workstation displays the form (step 62) which is completed by the potential donor (step 64). The completed form is uploaded (step 66). On receipt of the completed form, the trust web server 28 analyzes the content of the form (step 68) to determine whether information is complete (step 70). If the information is not complete, an error message is returned (step 72) and the process is reiterated in a manner well known in the art until the form is correctly completed, or the potential donor abandons the process.

When the form is correctly completed, the trust web server may consult an internal unpublished list of current companies from which private stock will be accepted. The list also preferably includes the names of all holders of the private stock in the respective companies known to the managers 16. If the company is located in the list and the potential donor name is also located and determined to be a holder of private stock in the company, the trust web server 28 may record the donation of private stock as a provisional donation (step 74), pending review and approval by the private trust managers 16. The trust web server may further compute the provisional trust units (step 76) and generate a provisional trust certificate (step 78), which is returned to the potential donor (step 80). The potential donor then prints the provisional trust certificate (step 82).

Concurrently, the trust web server sends the provisional trust information (step 84) to the trust management server 24 where it is brought to the attention of the trust managers 16 by an alert displayed on trust management workstation 26 (FIG. 2). The provisional donation is logged in step 86 and reminder dates are created (step 88) which provide reminders at predetermined intervals to prompt the private trust managers 16 to follow up on the provisional donation. A provisional donation is not finalized until the private stock certificates and attendant permission letters are received by the trust managers 16. After the private stock certificates and attendant permission letters are received, the trust managers 16 operate the trust management server 24 to convert the provisional donation to a private stock donation and to issue trust unit certificates to replace the provisional certificates generated by the trust web server 28.

It should be noted that the above-described automated process for donating private stock to the private trust 10 is only one example of how the process may be conducted. As will be well understood by those skilled in the art, holders of private stock may prefer to deal directly with trust managers 16 and the donation process may be a verbal or off-line process conducted by written or verbal communication rather than the on-line process described above.

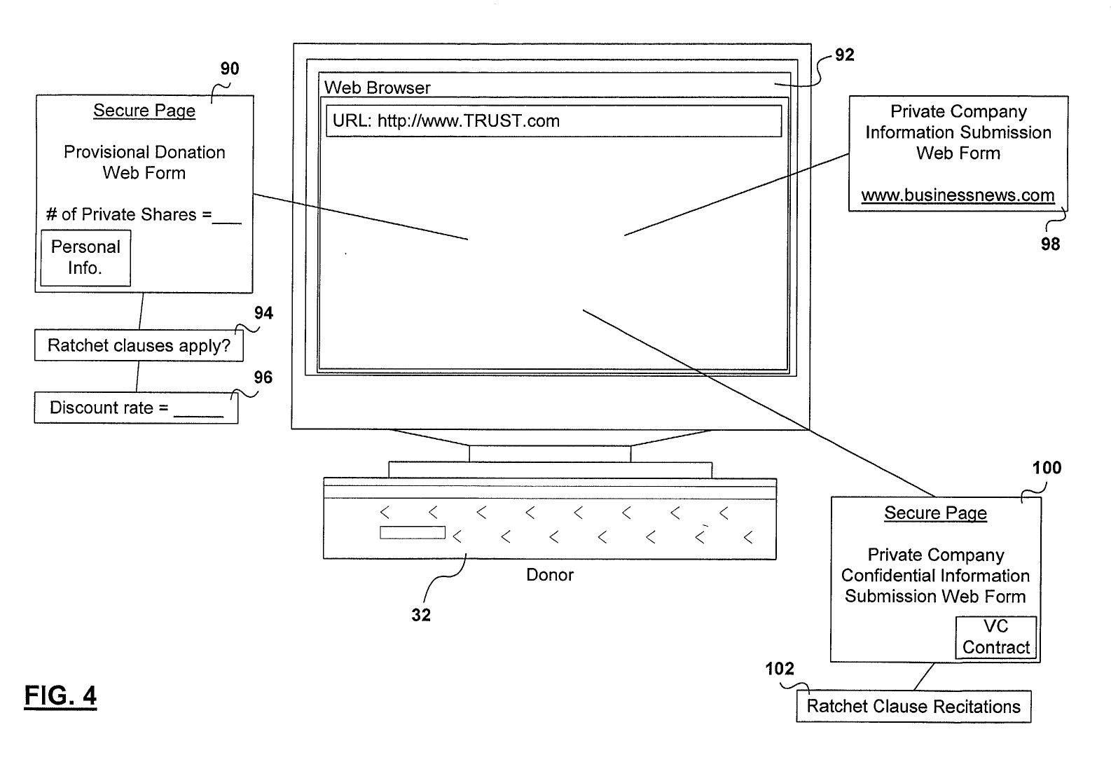

FIG. 4 illustrates a donor workstation 32 which is used to complete the provisional donation web form described above with reference to FIG. 3. When the potential donor requests a provisional donation web form 90 using a web browser 92 to access the trust web server 28, the provisional donation web form 90 is preferably downloaded as a secure page to ensure that information provided by the potential stock donor cannot be intercepted or appropriated by third parties. The provisional donation web form may be populated by the trust web server with information about the company and the value of the privately-held stock. In that case, a potential donor may only be required to fill out personal information and supply the number of private shares to be donated to the private trust 10.

As is well known in the art, most venture capital contracts include “ratchet clauses” which are performance requirements that must be met by the company within specific, predetermined time periods. If the targets are not met in accordance with the provisions of the ratchet clauses, the company is normally required to issue more stock to the venture capitalists. In order to ensure that the value of stock held by the private trust 10 is not diluted by the exercise of ratchet clauses, the donator of the private stock may be required to determine whether the ratchet clauses will apply, for example, by completing an appropriate section 94 of the provisional donation web form 90. If the potential donor elects not to have ratchet clauses apply, the potential donor may opt to specify a preferred discount rate which is completed in another special section 96 of the provisional donation web form 90. As will be understood by those skilled in the art, the private stock donations are frequently interactively negotiated between the potential donor and the private trust managers 16. The provisional donation web form can, however, provide a framework for the negotiations, and may be used to complete the transaction.

In addition to using the web browser 92 to perform provisional donations, users may also submit information respecting their private company using a private company submission web form 98 that is accessed from the trust web server 28 in a manner well known in the art. The private information submission web form permits publicly available information about the company to be submitted by, for example, entering an URL which points to a source of public information about the company. For example, the URL may point to a magazine or newspaper article detailing the provisions of a venture capital funding round, or the like. The private company information submission web form 98 may also support the attachment of articles, brochures, or other electronic documents, tables or other information.

In some instances, a potential donor or other interested party may wish to submit information to the trust managers 16 which is not to be made public or accessible from the trust web server 28. In that case, the potential donor or other interested party may select a private company confidential information submission web form 100 which initiates a secure session that opens the confidential information submission web form 100. The web form 100 preferably supports the attachment of documents, such as venture capital contracts which may be used by the trust managers 16 to examine ratchet clauses, etc. Alternatively, a sub-page 102 may be used to enter ratchet clause recitations or other provisions imposed by a venture capital contract.

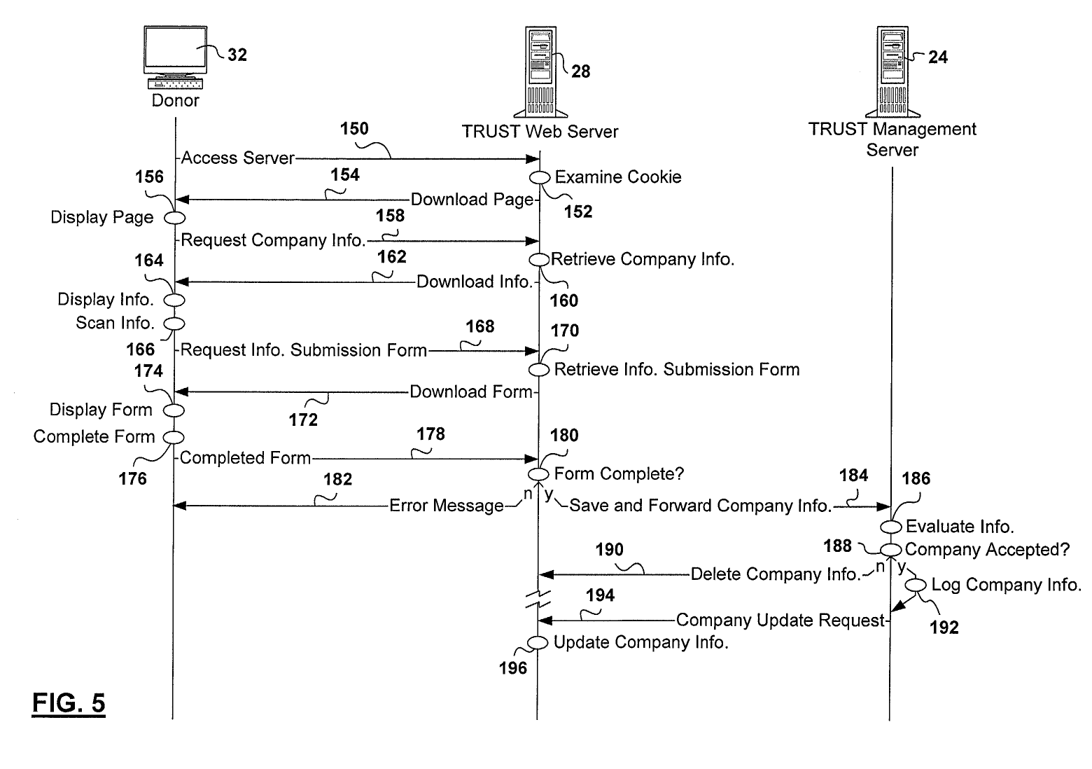

FIG. 5 details the process in which a potential donor, or other interested party, submits public information to the trust management system 25. The public information is used by trust managers 16 to determine whether donations of shares by holders of private shares in the company will be accepted by the private trust 10. In a first step of the process, the potential donor using donor workstation 32 accesses the trust web server 28 in step 150. As explained above, the trust web server 28 may examine a cookie passed by the donor workstation 32 in the process of determining an appropriate page to download to the potential donor (step 152). An appropriate page is selected using any predetermined criteria, and the page is downloaded (step 154). After download, the page is displayed (step 156) and the potential donor selects an appropriate button to request information about the company in which the potential donor holds stock (step 158). The trust web server responds by retrieving the company information, if available, (step 160) and downloads the information or an appropriate message (step 162). The information or message is displayed by the donor workstation 32 (step 164) and the potential donor scans the information (step 166). Subsequently, the potential donor requests an information submission form 98 (step 168), which is retrieved by the trust web server 28 (step 170) and downloaded (step 172). The form is displayed in step 174 and completed in step 176. The completed form is uploaded (step 178) and inspected to determine whether the information is complete in step 180. If it is not complete, an error message is returned in step 182. If the information is complete, the information is saved and forwarded to the trust management server 24 (step 184), which queues the information for evaluation by the trust managers 16. The trust managers 16 evaluate the information (step 186) and may determine whether the company is one from which private shares will be accepted as donations to the private trust 10 (step 188), if the submitted information proves to be material in that decision. If it is determined in step 188 that shares from that company are not to be accepted as donations to the private trust 10, the managers 16 may instruct the trust web server to delete the company information in step 190. Alternatively, if the company is accepted or if the information is inadequate to permit a decision to be made, the information may be logged (step 192) and the trust managers 16 may send a request to the trust web server (step 194) to update the company information with the new information supplied by the information submission form 98 in step 168. If so, the trust web server updates the company information file in step 196, and the process ends.

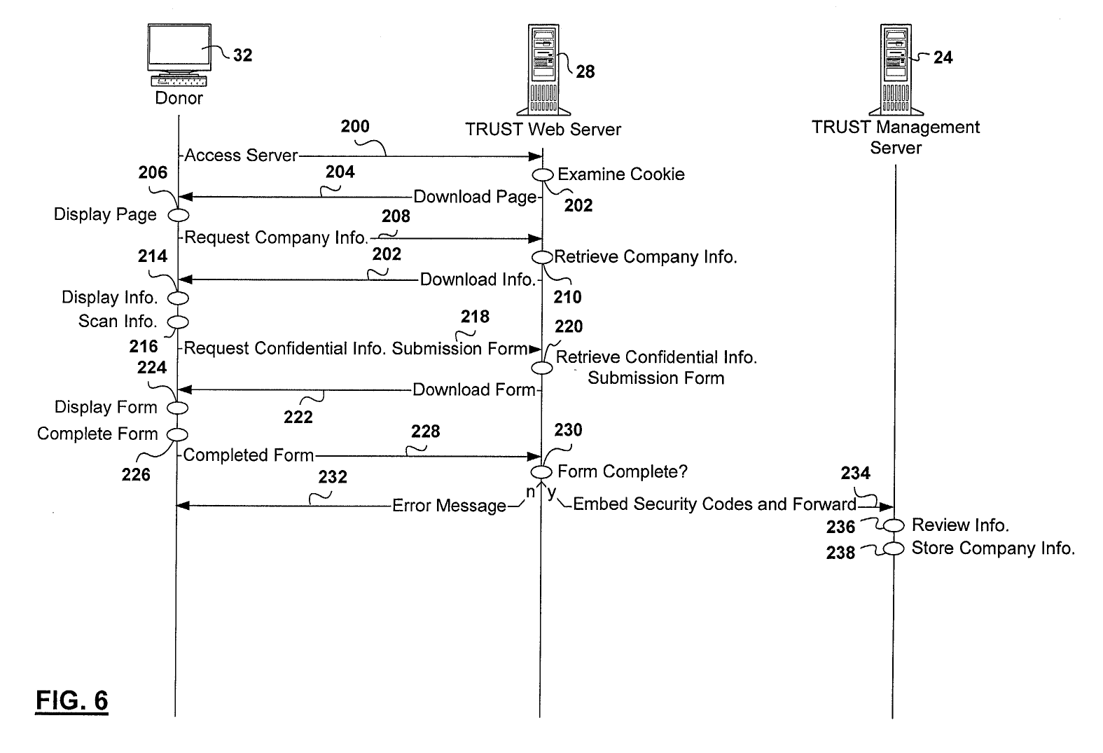

FIG. 6 is a schematic diagram illustrating the principal messages exchanged when a potential donor submits confidential information to the trust management system. In step 200, the potential donor, using donor workstation 32, accesses the web server 28. As described above, the trust web server 28 may optionally examine a cookie provided by the donor workstation 32 (step 202). The trust web server 28 selects an appropriate page and downloads the page in step 204. The page is displayed by the donor workstation 32 (step 206). The potential donor selects a button to request information related to a private company in which the potential donor owns private stock (step 208) and the information is retrieved by the web server 28 (step 210). The information is downloaded (step 212) and displayed (step 214). The potential donor scans the information (step 216) and decides to submit confidential information related to the private company.

The potential donor therefore requests a confidential information submission form (step 218) which is retrieved by the trust web server (step 220) and downloaded (step 222) to the donor workstation 32. The donor workstation 32 displays the form (step 224) which is completed by the potential donor (step 226). The form is, for example, the private company confidential information submission web form 100 described above with reference to FIG. 4. After the form is completed, the completed form is uploaded (step 228). When the completed form is received by the trust web server 28, the form is examined (step 230) to determine whether it is complete (contains information added by the potential donor, for example). If it is not complete, an error message is returned in step 232 and an iterative process ensues, as is well known in the art. If the form is complete, confidential information is forwarded in step 234 to the trust management server 24. Security codes are preferably embedded in the confidential information, or it is encrypted, before it is forwarded to the trust management server 24 so that only trust managers 16 can view the confidential information. Alternatively, the security codes can be inserted by the trust management server 24 after it is received.

An alert is sent to the trust managers 16 who retrieve the information (step 236) and inspect it. The information is then stored in the trust management server 24. Confidential information is not made available to the public on the trust web server 28.

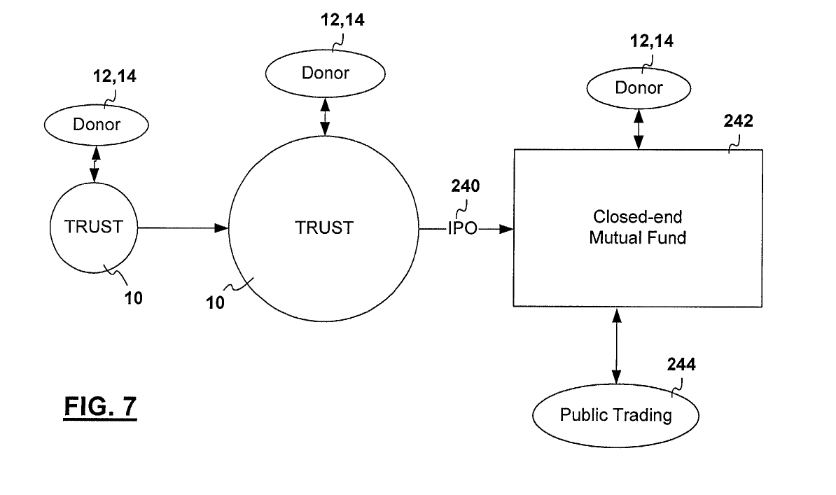

FIG. 7 illustrates the evolution of the private trust 10 as donations of private stock and cash are contributed to the private trust 10 by donors 12, 14. As the private trust 10 grows, the accumulated managed assets eventually reach a critical mass which permits an initial public offering (IPO) 240 to be tendered to permit the trust to evolve into a closed-end mutual fund 242. Public trading 244 is thereby enabled. This provides donors 12, 14 with more liquidity and enhances the ability to publicly trade in shares of the closed-end mutual fund.

With respect to private shares held by the private trust 10, the private shares may be disposed of in at least one of two different ways. First, the private company may be bought out by another company, in which case the private trust 10 receives payment for the private shares in cash or in shares in the acquiring company. As is well understood, the managers 16 may negotiate with the buyers for a price acceptable to the managers 16 of the private trust 10. Second, the private company may be converted to a public company by making an initial public offering (IPO). As is well understood in the art, when a private company becomes a public company through the instrument of the IPO, the private shares are converted to public shares. A trading in the public shares is frequently regulated and the shares are held in escrow for a predetermined period of time. During the escrow period, the private trust 10 is not permitted to dispose of the shares on the public market. Consequently, the trust management server 24 is preferably programmed to accept the input of an escrow date that is associated with the privately-held shares associated with a particular company. The trust manager server is also preferably programmed to generate at least one reminder to the trust managers 16 when the escrow period has expired. After the escrow period has expired, the private trust 10 may dispose of the public shares as the managers 16 deem appropriate. When public shares are sold, any profits are preferably dispersed to trust unit holders prior to an end of the fiscal year in which the sale was completed, in order to avoid tax liability on the part of the private trust. Thus, a donor of privately-held shares diversifies risk while receiving a share of profits realize from a plurality of sources.

The embodiment(s) of the invention described above is(are) intended to be exemplary only. The scope of the invention is therefore intended to be limited solely by the scope of the appended claims.

1. A method of diversifying risk in privately-held stock, comprising steps of:
accepting from a privately-held stock donor a donation to a trust of the privately-held stock, the privately-held stock conveying an ownership interest to the trust in a particular privately-held company;
issuing trust units to the privately-held stock donor in proportion to a value of the privately-held stock donated to the trust;
managing the trust to earn income; and
distributing the income to holders of the trust units in a direct proportion to the number of trust units held by each holder of the trust units.

2. The method as claimed in claim 1 further comprising a step of accepting a cash donation to the trust from a cash donor and issuing trust units to the cash donor in proportion of an amount of cash donated to the trust.

3. The method as claimed in claim 1 further comprising a step of paying an annual management fee to managers of the trust before distributing the income to holders of the trust units.

4. The method as claimed in claim 1 wherein the step of managing the trust further comprises steps of:
evaluating private companies to determine whether any one of the private companies is a company in which a manager of the trust is willing to accept a donation of stock to convey an ownership interest in the company to the trust; and
advising owners of privately-held stock in the companies in which the manager is willing to accept the donation that the trust is willing to accept donations of the privately-held stock in exchange for trust units.

5. The method as claimed in claim 4 wherein the step of evaluating comprises a step of searching public information sources for information about companies that have recently received significant venture capital funding.

6. The method as claimed in claim 5 further comprising steps of:
making a form available on the worldwide web page for accepting stock donations to the fund from a donor of the privately-held stock.

7. The method as claimed in claim 6 further comprising steps of provisionally accepting donations of privately-held stock to the fund by permitting the donor to complete the form to submit the donation of privately-held stock to the fund.

8. The method as claimed in claim 7 further comprising a step of provisionally issuing trust units to the donor of the privately-held stock on verification that the form was correctly completed.

9. The method as claimed in claim 8 further comprising a steps of:
reviewing the provisional acceptance of the donation of privately-held stock to verify that the donor is a valid donor owning the stock in the privately-held company;
waiting for receipt of privately-held stock certificates transferring an ownership interest in the privately-held company to the trust; and
on receipt of the privately-held stock certificates, issuing a trust unit certificate to the donor of the privately-held stock to replace the provisionally issued trust units.

10. The method as claimed in claim 9 further comprising a step of assigning an issue date to the trust unit certificate of the date on which the provisional donation was accepted, so that the donor of the privately-held stock earns income from the trust as of the issue date.

11. The method as claimed in claim 1 wherein the step of managing the trust further comprises steps of:
receiving from a potential donor an offer to donate to the trust privately-held stock representing an ownership interest in a private company;
evaluating the private company to determine whether the private company is a company in which a manager of the trust is willing to accept a donation of the privately-held stock to convey an ownership interest in the company to the trust; and
advising the owner of the privately-held stock whether the manager is willing to accept the donation of the privately-held stock in exchange for trust units.

12. The method as claimed in claim 11 wherein the step of evaluating comprises steps of:
examining publicly available information sources to determine whether the private company has recently acquired venture capital funding; and
determining whether the amount of venture capital funding meets a predetermined criteria.

13. The method as claimed in claim 1 wherein the step of managing the trust further comprises steps of:
monitoring the companies in which the trust has an ownership interest to determine when a one of the companies is a subject of a takeover bid by another company; and
selling the privately-held stock to the other company if an offered price for the privately-held stock is deemed appropriate by a manager of the trust, in order to generate income for the trust.

14. The method as claimed in claim 1 wherein the step of managing the trust further comprises steps of:
using cash available in the trust to purchase public stock options that cannot be exercised by a holder of the public stock options;
exercising the public stock options to purchase the public stock at a time deemed appropriate by a manager of the trust; and
selling the public stock at a time deemed appropriate by a manager of the trust in order to generate income for the trust.

15. The method as claimed in claim 1 wherein the step of managing the trust further comprises steps of:
monitoring the companies in which the trust has an ownership interest to determine when a one of the companies performs an initial public offering;
indicating that the privately-held stock has been converted to public stock in the company; and
selling the public stock at an appropriate time in order to generate income for the trust.

16. The method as claimed in claim 1 wherein the step of managing the trust further comprises a step of using cash from the trust to provide bridge financing to a company that is preparing for an initial public offering, in order to generate income for the trust.

17. The method as claimed in claim 16 wherein the bridge financing is provided to a company in which the trust owns an interest.

18. The method as claimed in claim 1 further comprising a step of converting the trust into a publicly traded closed-end mutual fund.

19. A system for managing a trust to diversify risk in privately-held stock, comprising:
a memory for storing contact information related to holders of units of the trust, and the number of trust units held by each holder of the units;
a memory for storing information related to each company in which the trust holds an ownership interest, including information defining the privately-held stock related to the company that is held in the trust;
a memory for storing information related to cash and other assets owned by the trust;
a processor for executing program instructions;
program instructions for permitting the memories to be written, read and rewritten by the processor to enable the contact information, company information, stock information, cash and other asset information to be retrieved, inspected and updated, as required;
program instructions for accepting input indicating a donation of private shares conveying an ownership interest in a private company to the trust, the program instructions further permitting an input of information related to a donor of the private shares, and of a value of the private shares;
program instructions for computing a number of units of the trust to be issued to the donor of the private shares to the trust in proportion to the value of the private shares input; and
program instructions for computing a share of income of the trust to be distributed to each holder of units in the trust in direct relation to a number of units held by the holder of units.

20. The system as claimed in claim 19 further comprising:
program instructions for accepting input indicating a contribution of cash to the trust, the program instructions further permitting an input of information related to a donor of the cash to the trust; and
program instructions for computing a number of units of the trust to be issued to the donor of the cash based on a value of the cash donated to the trust.

21. The system as claimed in claim 19 further comprising:
program instructions for accepting input indicating a conversion of privately-held stock held by the trust to public stock held by the trust; and
program instructions for accepting input indicating a value of the public stock held by the trust.

22. The system as claimed in claim 21 further comprising:
program instructions for accepting and storing an escrow date indicating a predetermined time period during which the public stock cannot be traded; and
program instructions for displaying a reminder to a manager of the trust when the predetermined time period has expired, to permit the manager to sell at least a proportion of the public stock to earn income for the trust.

23. The system as claimed in claim 19 further comprising:
program instructions for accepting input indicating a sale of the public stock held by the trust;
program instructions for accepting input indicating a value of the public stock sold from the trust; and
program instructions for computing income to the trust based on the value of the stock sold from the trust.

24. The system as claimed in claim 23 further comprising program instructions for computing income distributions to holders of units of the trust.

25. The system as claimed in claim 19 further comprising a worldwide web server having at least one publicly available worldwide web page for displaying information describing the trust and displaying public information about at least one privately-held company from which a manager of the trust is willing to accept a donation of privately-held stock.

26. The system as claimed in claim 25 further comprising a worldwide web form available on the at least one publicly available worldwide web page that permits a donor of the privately-held stock to provisionally donate the privately-held stock to the trust.

27. The system as claimed in claim 26 further comprising program instructions for provisionally issuing trust units to the donor of the privately-held trust when the donor provisionally donates the privately-held stock by correctly completing the worldwide web form.

28. The system as claimed in claim 27 further comprising program instructions for reporting to a manager of the trust that the privately-held stock has been provisionally donated to the trust, and for further informing the manager of the number of trust units that have been provisionally issued to the donor of the privately-held stock.

29. The system as claimed in claim 27 further comprising program instructions for sending a request for logging the provisional donation, the provisional issue of trust units and information identifying the private company and the donor of the privately-held stock to the processor to permit the memories to be updated.

30. The system as claimed in claim 25 wherein the worldwide web server further comprises a publicly available worldwide web page that enables input of information related to a privately-held company to permit a manager of the trust to determine whether a donation of privately-held stock in the company will be accepted by the trust.

31. The system as claimed in claim 30 wherein the information may be input as a universal resource locator (URL) for directing the manager to a source of public information related to the privately-held company.

32. The system as claimed in claim 30 wherein the worldwide web page permits the user to invoke a secure connection to the worldwide web server to permit the user to input private information related to the privately-held company, the private information being made available only to managers of the trust.

33. The system as claimed in claim 32 wherein the private information relates to ratchet clauses in a venture capital financing agreement entered into by the privately-held company.

34. The system as claimed in claim 32 wherein the information relates to a private share discount percentage that the private donor is willing to accept in lieu adherence to ratchet clauses in a venture capital financing agreement entered into by the privately-held company.

35. The system as claimed in claim 32 wherein information provided through the secure connection is protected by security codes embedded by a processor on the worldwide web server so that the information can only be examined by managers of the trust.

36. A method of diversifying risk in privately-held stock, comprising steps of:
accepting the privately-held stock into a private trust, the privately-held stock being donated to the private trust by a donor, so that the private trust acquires the privately-held stock without charge;
issuing trust units to the donor of the privately-held stock in proportion to a value of the privately-held stock donated to the private trust;
managing the private trust to earn income;
paying management fees to managers of the private trust; and
distributing remaining income to holders of the trust units in a direct proportion to the number of trust units held by each holder of the trust units.

37. A method as claimed in claim 36 wherein the step of managing the trust further comprises a steps of:
determining when privately-held stock in the trust is converted to public stock during an initial public offering by the company;
recording an escrow period during which the public stock cannot be sold by the private trust;
noting when the escrow period has expired; and
selling the public shares at a time deemed appropriate by the managers of the private trust to earn income for the trust.

38. A method as claimed in claim 36 wherein the step of managing the trust further comprises steps of using cash reserves in the trust to perform any one of:
buying public stock options that cannot be exercised by an owner of the options;
buying public stock at a discount; and
providing bridge financing to private companies preparing for an initial public offering.

39. A system for managing a private trust to diversify risk in privately-held stock, comprising:
a trust management server for facilitating management of the private trust by at least one manager, the trust management server permitting the at least one manager to determine the number of privately-held shares owned by the private trust, a value of the shares, and a value of other assets owned by the private trust;
at least one trust management workstation connected to the trust management server; and
a trust web server to permit potential donors to the private trust to learn about the private trust, and to post information about a private company to permit at least manager of the private trust to determine whether the private trust will accept donations of privately-held stock in the company.

40. A system as claimed in claim 39 wherein the trust web server further comprises forms for permitting the potential donor to post both private and public information about the company.

41. A system as claimed in claim 40 wherein the trust web server further comprises a secure web form for permitting the private information to be submitted, and security codes are embedded in the private information to ensure that only trust managers can view the private information.

42. A system as claimed in claim 39 wherein the trust web server further comprises a provisional donation web form to permit a potential donor of privately-held stock to provisionally donate the privately-held stock, the provisional donation web form permitting the potential donor to specify the company in which the privately-held shares conveys an ownership interest, personal information, the number of shares to be donated and a value of the shares.

43. A system as claimed in claim 42 wherein the provisional donation web form further comprises an option to permit the potential donor to specify whether ratchet clauses in a venture capital contract signed by the private company will be complied with in respect of privately-held shares donated to the private trust.

44. A system as claimed in claim 43 wherein the provisional donation web form further comprises an option to permit the potential donor to specify a discount rate for the privately-held stock, rather than elect the option of complying with the ratchet clauses.

45. A system as claimed in claim 39 wherein the trust management server further comprises program instructions for tracking cash and other assets of the private trust.
